(19) United States
(12) Patent Application Publication
(10) Pub. No.: US 2025/0156033 A1
(43) Pub. Date: May 15, 2025

(54) APPLICATION MENU USER INTERFACE

(71) Applicant: Apple Inc., Cupertino, CA (US)

(72) Inventors: Imran A. CHAUDHRI, San Francisco, CA (US); Freddy A. ANZURES, San Francisco, CA (US); Greg CHRISTIE, San Jose, CA (US); Scott HERZ, San Jose, CA (US); Steven P. JOBS, Palo Alto, CA (US)

(21) Appl. No.: 19/020,964

(22) Filed: Jan. 14, 2025

Related U.S. Application Data
(63) Continuation of application No. 18/401,007, filed on Dec. 29, 2023.
(63) Continuation of application No. 17/478,594, filed on Sep. 17, 2021, now Pat. No. 11,861,138.
Application No. 17/478,594 is a continuation of application No. 11/850,005, filed on Sep. 4, 2007, now Pat. No. 11,126,321.

(51) Int. Cl. G06F 3/04817; G06F 3/0482; G06F 3/0483; G06F 3/04883

(52) U.S. Cl. CPC G06F 3/04817; G06F 3/0482; G06F 3/0483; G06F 3/04883

(57) ABSTRACT

Methods, systems, and apparatus, including computer program products, for presenting user interface elements. A first page of one or more user interface elements is presented on a touch-sensitive display. Each of the user interface elements corresponds to a respective application. A gesture performed on the touch-sensitive display is detected. In response to the detected gesture, a second page of one or more user interface elements is presented on the touch-sensitive display.

### CROSS-REFERENCE TO RELATED APPLICATIONS

This Application is a continuation of U.S. Nonprovisional application Ser. No. 11/850,005, filed on Sep. 4, 2007, entitled “APPLICATION MENU USER INTERFACE”, which is hereby incorporated by reference in its entity for all purposes.

### BACKGROUND

The subject matter of this specification relates generally to graphical user interfaces. Many of today's computers and devices include a graphical user interface (“GUI”), through which a user can interact with the computer or device. A GUI can include various user interface elements, such as windows, scroll bars, and so on. For example, a GUI of a device can include a menu for launching applications on the device. The menu can include a number of user interface elements, each corresponding to an application or functionality on the device. Usability of the menu interface is particularly important, as the menu is a gateway to much of the functionality on the device.

### SUMMARY

In general, one aspect of the subject matter described in this specification can be embodied in methods that include presenting a first page of one or more user interface elements on a touch-sensitive display, where each of the user interface elements corresponding to a respective application; detecting a gesture performed on the touch-sensitive display; and in response to the detected gesture, presenting a second page of one or more user interface elements on the touch-sensitive display. Other embodiments of this aspect include corresponding systems, apparatus, computer program products, and computer readable media.

In general, another aspect of the subject matter described in this specification can be embodied in methods that include presenting a first user interface element corresponding to a first application on a device, where the first application has an unrestricted status; simultaneous with presenting the first user interface element, presenting a second user interface element corresponding to a second application on the device, where the second application has a restricted status, and presenting an indication of the restricted status; changing the restricted status of the second application to an unrestricted status; and in response to changing the restricted status, presenting the second user interface element without the indication of the restricted status. Other embodiments of this aspect include corresponding systems, apparatus, computer program products, and computer readable media.

In general, another aspect of the subject matter described in this specification can be embodied in methods, implemented on a device with a touch-sensitive display, that include displaying at least a subset of a plurality of user interface elements in a user interface in an ergonomic layout, where each user interface element corresponds to a respective application on the device. Other embodiments of this aspect include corresponding systems, apparatus, computer program products, and computer readable media.

In general, another aspect of the subject matter described in this specification can be embodied in methods that include presenting a user interface element corresponding to an application on a display device; presenting a graphical representation of a reflection of the user interface element; receiving an input selecting the graphical representation; and presenting information associated with the application in response to the input. Other embodiments of this aspect include corresponding systems, apparatus, computer program products, and computer readable media.

Particular embodiments of the subject matter described in this specification can be implemented to realize one or more of the following advantages. A device can include a more user-friendly and/or ergonomic application menu. Trial applications can be presented in an application menu of the device with an indication of their trial status. A user of the device can try a trial application and remove the trial status of the trial application from the device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example mobile device with telephony capability.

FIG. 1B is a block diagram of an example mobile device without telephony capability.

FIG. 2 is a block diagram of an example network operating environment for the mobile devices of FIGS. 1A-1B.

FIG. 3 is a block diagram of an example implementation of the mobile devices of FIGS. 1A-1B.

FIG. 4A illustrates an example implementation of a software stack for the mobile devices of FIGS. 1A-1B

FIG. 4B illustrates an example implementation of a security process for remote access management over a secure communications channel.

FIG. 5 illustrates an example process for presenting information on a touch-sensitive display of a mobile device.

FIG. 6 illustrates an example process for indicating a restricted status of a user interface element on a mobile device.

FIG. 7A is a block diagram of an example mobile device with a vertically scrolling application menu on a touch-sensitive display.

FIG. 7B is a block diagram of an example mobile device with a vertically scrolling application menu on a touch-sensitive display.

FIG. 7C is a block diagram of an example mobile device with a vertically scrolling application menu on a touch-sensitive display.

FIG. 8A is a block diagram of an example mobile device with a horizontally scrolling application menu on a touch-sensitive display.

FIG. 8B is a block diagram of an example mobile device with a horizontally scrolling application menu on a touch-sensitive display.

FIG. 8C is a block diagram of an example mobile device with a horizontally scrolling application menu on a touch-sensitive display.

FIG. 9A is a block diagram of an example mobile device with an ergonomic application menu layout.

FIG. 9B is a block diagram of an example mobile device with an ergonomic application menu layout.

FIG. 10A is a block diagram of an example mobile device displaying user interface elements which have a restricted status.

FIG. 10B is a block diagram of an example mobile device displaying an information dialog regarding an interface element which has a restricted status.

FIG. 10C is a block diagram of an example mobile device displaying user interface elements which have a restricted status.

FIG. 11 is a block diagram of an example mobile device with interface elements docked to a menu tray floor.

Like reference numbers and designations in the various drawings indicate like elements.

### DETAILED DESCRIPTION

### Example Mobile Device

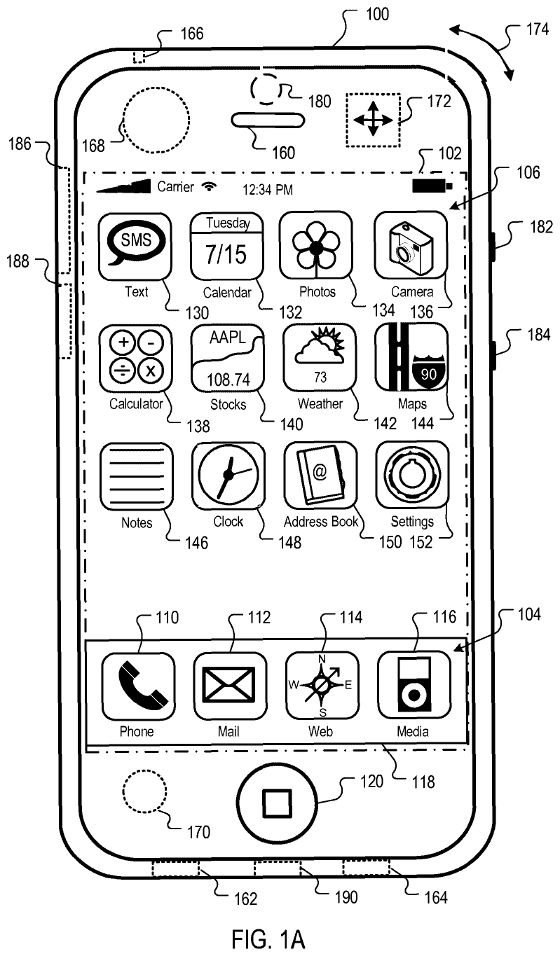

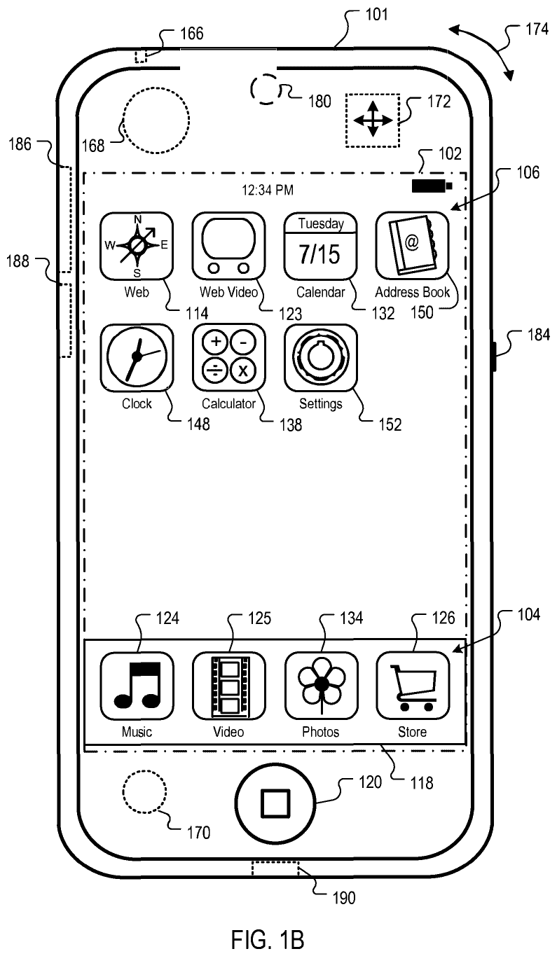

FIG. 1A is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106 are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1A. Touching one of the objects 110, 112, 114, or 116 can, for example, invoke corresponding functionality.

In some implementations, the mobile device 100 can implement network distribution functionality. For example, the functionality can enable the user to take the mobile device 100 and provide access to its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1A can be restored by pressing a button 120 located near the bottom of the mobile device 100. In some implementations, each corresponding device functionality may have corresponding “home” display objects displayed on the touch-sensitive display 102, and the graphical user interface environment of FIG. 1A can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150, and 152 can invoke a corresponding object environment and functionality.

Additional and/or different display objects can also be displayed in the graphical user interface of FIG. 1A. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, an up/down button 184 for volume control of the speaker 160 and the microphone 162 can be included. The mobile device 100 can also include an on/off button 182 for a ring indicator of incoming phone calls. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, a display screen, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol. In some implementations, a TCP/IP over USB protocol can be used, as described in U.S. Provisional Patent Application No. 60/945,904, filed Jun. 22, 2007, for “Multiplexed Data Stream Protocol,” which provisional patent application is incorporated by reference herein in its entirety.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Mobile Device

FIG. 1B is a block diagram of an example mobile device 101. The mobile device 101 can be, for example, a handheld computer, a laptop computer, a personal digital assistant, a network appliance, a camera, a network base station, a media player, a navigation device, an email device, a game console, or a combination of any two or more of these data processing devices or other data processing devices. In some implementations, device 101 shown in FIG. 1B is an example of how device 100 can be configured to display a different set of objects. In some implementations, device 101 has a different set of device functionalities than device 100 shown in FIG. 1A, but otherwise operates in a similar manner to device 100.

### Mobile Device Overview

In some implementations, the mobile device 101 includes a touch-sensitive display 102, which can be sensitive to haptic and/or tactile contact with a user. In some implementations, the mobile device 101 can display one or more graphical user interfaces on the touch-sensitive display 102 for providing the user access to various system objects and for conveying information to the user.

### Mobile Device Functionality

In some implementations, the mobile device 101 can implement multiple device functionalities, such as a music processing device, as indicated by the music player object 124, a video processing device, as indicated by the video player object 125, a digital photo album device, as indicated by the photos object 134, and a network data communication device for online shopping, as indicated by the store object 126. In some implementations, particular display objects 104, e.g., the music player object 124, the video player object 125, the photos object 134, and store object 126, can be displayed in a menu bar 118. In some implementations, device functionalities can be accessed from a top-level graphical user interface, such as the graphical user interface illustrated in FIG. 1B. Touching one of the objects 124, 125, 134, or 126 can, for example, invoke corresponding functionality.

In some implementations, the top-level graphical user interface of mobile device 101 can include additional display objects 106, such as the Web object 114, the calendar object 132, the address book object 150, the clock object 148, the calculator object 138, and the settings object 152 described above with reference to mobile device 100 of FIG. 1A. In some implementations, the top-level graphical user interface can include other display objects, such as a Web video object 123 that provides functionality for uploading and playing videos on the Web. Each selection of a display object 114, 123, 132, 150, 148, 138, and 152 can invoke a corresponding object environment and functionality.

Additional and/or different display objects can also be displayed in the graphical user interface of FIG. 1B. In some implementations, the display objects 106 can be configured by a user. In some implementations, upon invocation of device functionality, the graphical user interface of the mobile device 101 changes, or is augmented or replaced with another user interface or user interface elements, to facilitate user access to particular functions associated with the corresponding device functionality.

In some implementations, the mobile device 101 can include audio jack 166, a volume control device 184, sensor devices 168, 170, 172, and 180, wireless communication subsystems 186 and 188, and a port device 190 or some other wired port connection described above with reference to mobile device 100 of FIG. 1A.

### Network Operating Environment

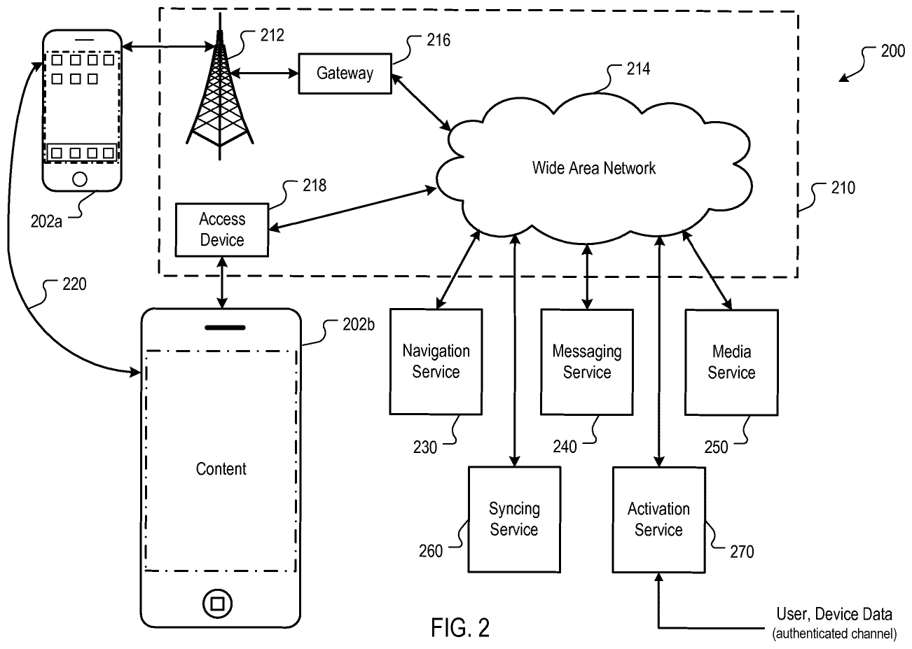

FIG. 2 is a block diagram of an example network operating environment 200. In FIG. 2, mobile devices 202a and 202b each can represent mobile device 100 or 101. Mobile devices 202a and 202b can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access device 218, such as an 802.1 LG wireless access device, can provide communication access to the wide area network 214. In some implementations, both voice and data communications can be established over the wireless network 212 and the access device 218. For example, the mobile device 202a can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, in some implementations, the mobile device 202b can place and receive phone calls, send and receive e-mail messages, and retrieve electronic documents over the access device 218 and the wide area network 214. In some implementations, the mobile device 202a or 202b can be physically connected to the access device 218 using one or more cables and the access device 218 can be a personal computer. In this configuration, the mobile device 202a or 202b can be referred to as a “tethered” device.

The mobile devices 202a and 202b can also establish communications by other means. For example, the wireless device 202a can communicate with other wireless devices, e.g., other mobile devices 202a or 202b, cell phones, etc., over the wireless network 212. Likewise, the mobile devices 202a and 202b can establish peer-to-peer communications 220, e.g., a personal area network, by use of one or more communication subsystems, such as the Bluetooth™ communication devices 188 shown in FIGS. 1A-1B. Other communication protocols and topologies can also be implemented.

The mobile device 202a or 202b can, for example, communicate with one or more services 230,240,250,260, and 270 over the one or more wired and/or wireless networks 210. For example, a navigation service 230 can provide navigation information, e.g., map information, location information, route information, and other information, to the mobile device 202a or 202b. A user of the mobile device 202b can invoke a map functionality, e.g., by pressing the maps object 144 on the top-level graphical user interface shown in FIG. 1A, and can request and receive a map for a particular location.

A messaging service 240 can, for example, provide e-mail and/or other messaging services. A media service 250 can, for example, provide access to media files, such as song files, audio books, movie files, video clips, and other media data. In some implementations, separate audio and video services (not shown) can provide access to the respective types of media files. A syncing service 260 can, for example, perform syncing services (e.g., sync files). An activation service 270 can, for example, perform an activation process for activating the mobile device 202a or 202b. Other services can also be provided, including a software update service that automatically determines whether software updates exist for software on the mobile device 202a or 202b, then downloads the software updates to the mobile device 202a or 202b where the software updates can be manually or automatically unpacked and/or installed.

The mobile device 202a or 202b can also access other data and content over the one or more wired and/or wireless networks 210. For example, content publishers, such as news sites, RSS feeds, web sites, blogs, social networking sites, developer networks, etc., can be accessed by the mobile device 202a or 202b. Such access can be provided by invocation of a web browsing function or application (e.g., a browser) in response to a user touching the Web object 114.

### Example Mobile Device Architecture

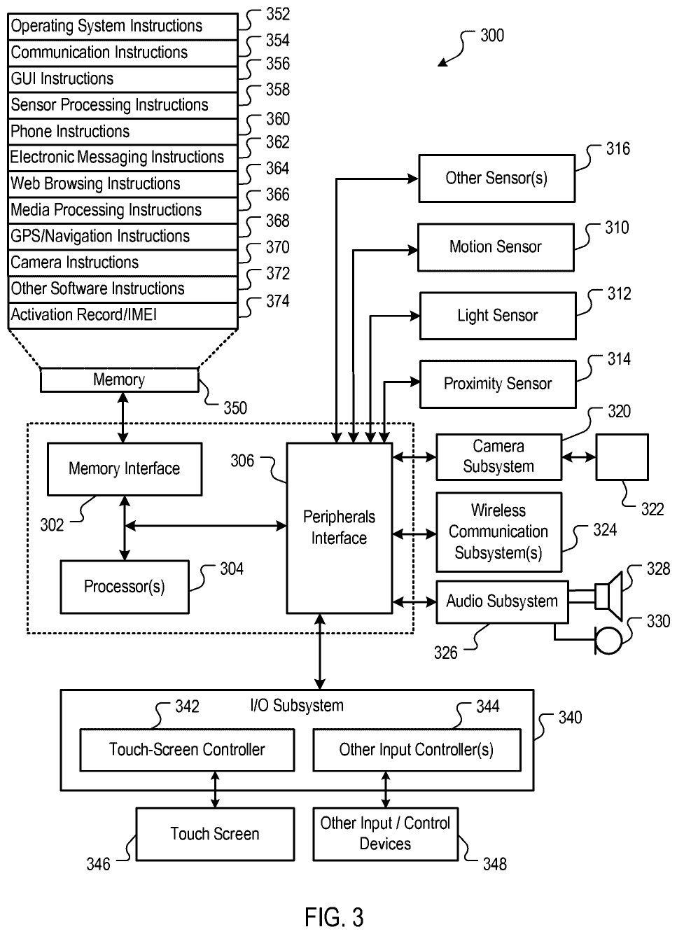

FIG. 3 is a block diagram 300 of an example implementation of the mobile devices 100 and 101 of FIGS. 1A-1B, respectively. The mobile device 100 or 101 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 or 101 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting, and proximity functions described with respect to FIG. 1A. Other sensors 316 can also be connected to the peripherals interface 306, such as a positioning system (e.g., GPS receiver), a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 or 101 is intended to operate. For example, a mobile device 100 or 101 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 or 101 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 or 101 on or off. The user may be able to customize a functionality of one or more of the buttons. The touch screen 346 can, for example, also be used to implement virtual or soft buttons and/or a keyboard.

In some implementations, the mobile device 100 or 101 can present recorded audio and/or video files, such as MP3, AAC, and MPEG files. In some implementations, the mobile device 100 or 101 can include the functionality of an MP3 player, such as an iPod™. The mobile device 100 or 101 may, therefore, include a 36-pin connector that is compatible with the iPod. Other input/output and control devices can also be used.

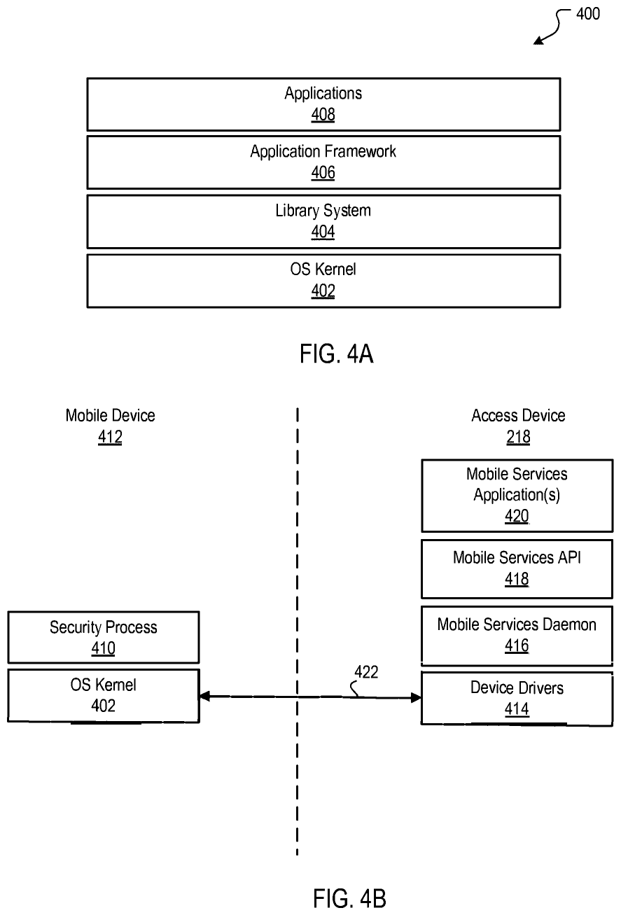

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel), as described in reference to FIGS. 4A and 4B.

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions, e.g., security processes and functions as described in reference to FIGS. 4A and 4B. The memory 350 may also store other software instructions (not shown), such as web video instructions to facilitate web video-related processes and functions; and/or web shopping instructions to facilitate web shopping-related processes and functions. In some implementations, the media processing instructions 366 are divided into audio processing instructions and video processing instructions to facilitate audio processing-related processes and functions and video processing-related processes and functions, respectively. An activation record and International Mobile Equipment Identity (IMEI) 374 or similar hardware identifier can also be stored in memory 350.

Each of the above identified instructions and applications can correspond to a set of instructions for performing one or more functions described above. These instructions need not be implemented as separate software programs, procedures, or modules. The memory 350 can include additional instructions or fewer instructions. Furthermore, various functions of the mobile device 100 or 101 may be implemented in hardware and/or in software, including in one or more signal processing and/or application specific integrated circuits.

### Software Stack and Security Process

FIG. 4A illustrates an example implementation of a software stack 400 for the mobile devices of FIGS. 1A-1B. In some implementations, the software stack 400 includes an operating system (OS) kernel 402 (e.g., a UNIX kernel), a library system 404, an application framework 406 and an applications layer 408.

The OS kernel 402 manages the resources of the mobile device 100 or 101 and allows other programs to run and use these resources. Some examples of resources include a processor, memory, and I/O. For example, the kernel 402 can determine which running processes should be allocated to a processor, processors or processor cores, allocates memory to the processes and allocates requests from applications and remote services to perform I/O operations. In some implementations, the kernel 402 provides methods for synchronization and inter-process communications with other devices.

In some implementations, the kernel 402 can be stored in non-volatile memory of the mobile device 100 or 101. When the mobile device 100 or 101 is turned on, a boot loader starts executing the kernel 102 in supervisor mode. The kernel then initializes itself and starts one or more processes for the mobile device 100 or 101, including a security process 410 for remote access management, as described in reference to FIG. 4B.

The library system 404 provides various services applications running in the application layer 408. Such services can include audio services, video services, database services, image processing services, graphics services, etc.

The application framework 406 provides an object-oriented application environment including classes and Application Programming Interfaces (APIs) that can be used by developers to build applications using well-known programming languages (e.g., Objective-C, Java).

The applications layer 408 is where various applications exist in the software stack 400. Developers can use the APIs and environment provided by the application framework 406 to build applications, such as the applications represented by the display objects 104, 106, shown in FIGS. 1A-1B (e.g., email, media player, Web browser, phone, music player, video player, photos, and store).

### Secure Communication Channel

FIG. 4B illustrates an example implementation of a security process 410 for remote access management over a secure communications channel 422. In the example shown, the mobile device 412, e.g., mobile device 100 or 101, is running the security process 410, which communicates with the OS kernel 402. Any remote access requests made to the kernel 402 are intercepted by the security process 410, which is responsible for setting up secure communication sessions between the mobile device 412 and a mobile services access device 218. In some implementations, the process 410 uses a cryptographic protocol, such as Secure Sockets Layer (SSL) or Transport Layer Security (TLS) to provide secure communications between the mobile device 412 and the access device 218. The access device 218 can be any device with network connectivity, including but not limited to: a personal computer, a hub, an Ethernet card, another mobile device, a wireless base station, etc. The secure communications channel can be a Universal Serial Bus (USB), Ethernet, a wireless link (e.g., Wi-Fi, WiMax, 3G), an optical link, infrared link, FireWire™, or any other known communications channel or media.

In the example shown, the access device 218 includes device drivers 414, a mobile services daemon 416, a mobile services API 418 and one or more mobile service applications 420. The device drivers 414 are responsible for implementing the transport layer protocol, such as TCP/IP over USB. The mobile services daemon 416 listens (e.g., continuously) to the communications channel 422 for activity and manages the transmission of commands and data over the communication channel 422. The mobile services API 418 provides a set of functions, procedures, variables and data structures for supporting requests for services made by the mobile services application 420. The mobile services application 420 can be a client program running on the access device 218, which provides one or more user interfaces for allowing a user to interact with a remote service (e.g., activation service 270) over a network (e.g., the Internet, wireless network, peer-to-peer network, optical network, Ethernet, intranet). In some implementations, a device activation process can be used, as described in co-pending U.S. patent application Ser. No. 11/767,447, filed Jun. 22, 2007, for “Device Activation and Access,” which patent application is incorporated by reference herein in its entirety. The application 420 can allow a user to set preferences, download or update files of content or software, search databases, store user data, select services, browse content, perform financial transactions, or engage in any other online service or function. An example of a mobile services application 420 is the iTunes™ client, which is publicly available from Apple Inc. (Cupertino, CA). An example of a mobile device 412 that uses the iTunes™ client is the iPod™ product developed by Apple Inc. Another example of a mobile device 412 that uses the iTunes™ client is the iPhone™ product developed by Apple Inc.

In an example operational mode, a user connects the mobile device 412 to the access device 218 using, for example, a USB cable. In some other implementations, the mobile device 412 and access device 218 include wireless transceivers for establishing a wireless link (e.g., Wi-Fi). The drivers 414 and kernel 408 detect the connection and alert the security process 410 and mobile services daemon 416 of the connections status. Once the connection is established certain non-sensitive information can be passed from the mobile device 412 to the access device 218 (e.g., name, disk size, activation state) to assist in establishing a secure communication session.

In some implementations, the security process 410 establishes a secure communication session (e.g., encrypted SSL session) with the access device 218 by implementing a secure network protocol. For example, if using SSL protocol, the mobile device 412 and access device 218 will negotiate a cipher suite to be used during data transfer, establish and share a session key, and authenticate the access device 218 to the mobile device 412. In some implementations, if the mobile device 412 is password protected, the security process 410 will not establish a session, and optionally alert the user of the reason for failure.

Once a secure session is successfully established, the mobile device 412 and the access device 218 can exchange sensitive information (e.g., passwords, personal information), and remote access to the mobile device 412 can be granted to one or more services (e.g., navigation service 230, messaging service 240, media service 250, syncing service 260, activation service 270). In some implementations, the mobile services daemon 416 multiplexes commands and data for transmission over the communication channel 422. This multiplexing allows several remote services to have access to the mobile device 412 in a single session without the need to start a new session (or handshaking) for each service requesting access to the mobile device 412.

### Example Mobile Device Processes

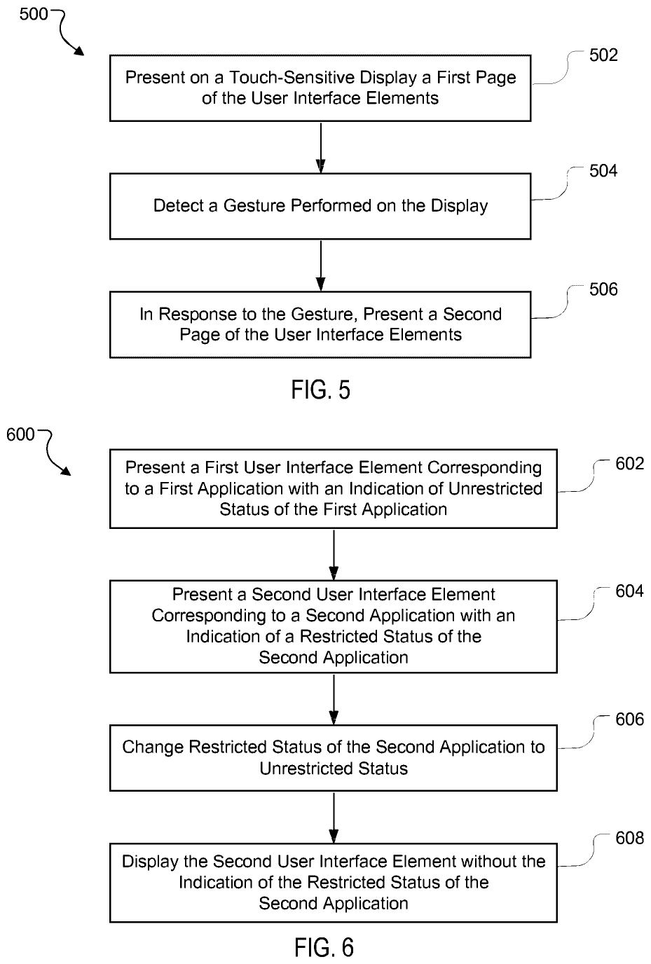

FIG. 5 illustrates an example process 500 for presenting information on a touch-sensitive display of a mobile device. In some implementations, the process 500 can be used with the mobile device 100 or 101, as described in reference to FIGS. 1A-1B. Generally, the process 500 includes presenting information in response to a user touch input.

The process 500 begins with presenting a first page of user interface elements on the touch-sensitive display of a mobile device (502). In some implementations, a page of user interface elements is a view on the display that is capable of presenting one or more user interface elements on the display, where the user interface elements can be related or unrelated. In some implementations, the first page of user interface elements is displayed on the mobile device upon powering up the mobile device. In some other implementations, a user interaction can trigger presentation of the page of user interface elements. For example, selection of the home button 120 (as shown in FIG. 1A) can present the user with an initial display screen including the first page of user interface elements. The user interface elements, for example, can include the display objects 106 (as shown in FIG. 1A). In some implementations, the first page of user interface elements is a first portion of an application menu.

A gesture performed on the touch-sensitive display is detected (504). In some implementations, the gesture includes a touch, tap, or dragging motion across the touch-sensitive display (e.g., using a finger, stylus, etc.). The gesture, in some implementations, is performed within a region where no user interface elements are displayed. For example, the user can perform a horizontal or vertical swipe across a blank region of the touch-sensitive display of the mobile device. In another example, the user can touch or tap a blank section of the display (e.g., to the top, bottom, left, or right of the blank region). In some implementations, a navigational guide may be displayed to the user. The user can, for example, touch or swipe a region of the navigational guide.

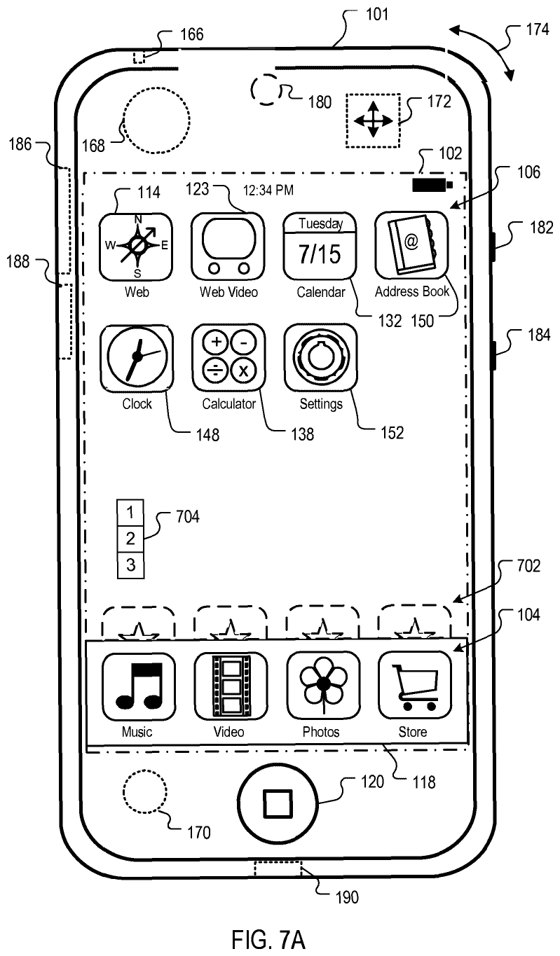

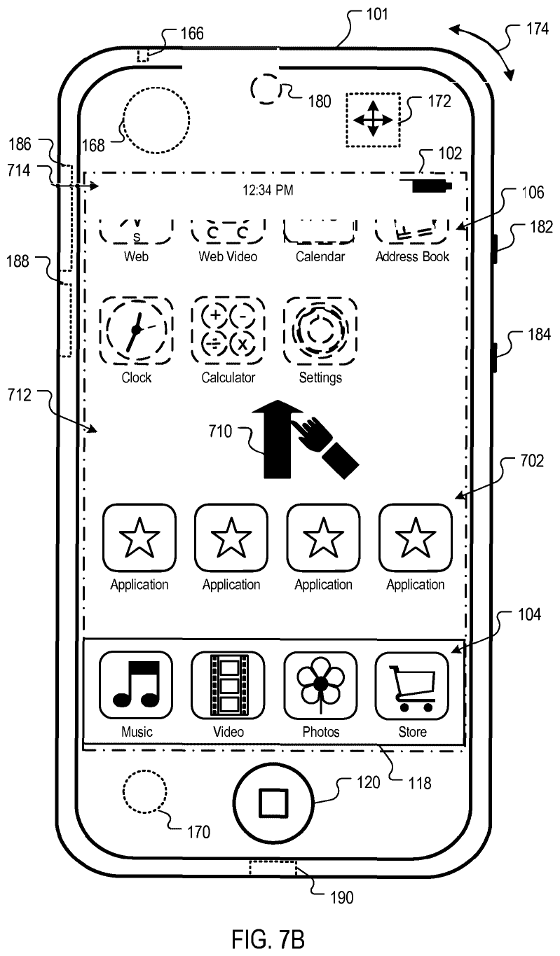

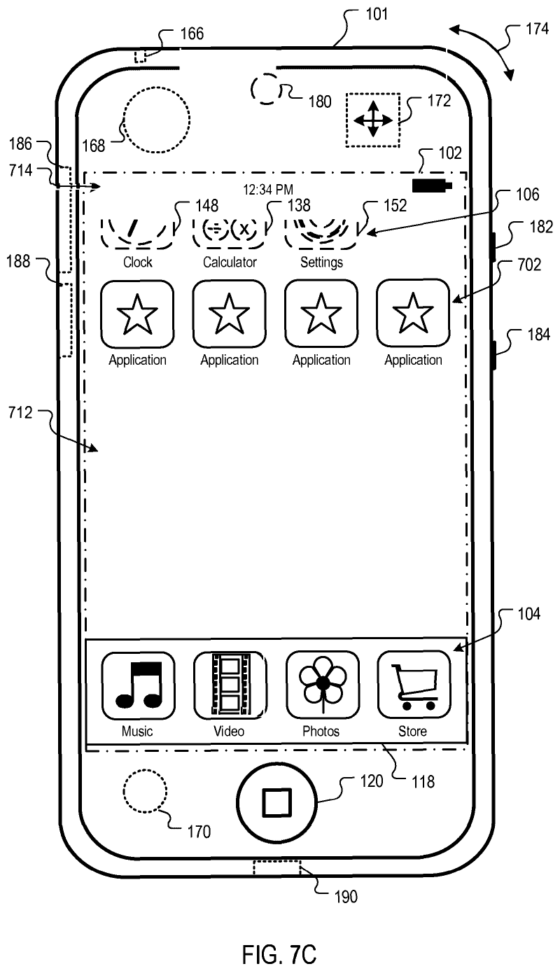

In response to the gesture, a second page of user interface elements is presented (506). In some implementations, the second page of user interface elements is a second portion of the application menu. In some implementations, the user is provided with an indication that a second page of user interface elements is available for display. For example, when the first page of user interface elements is displayed, a portion of one or more of the second pages of user interface elements can be visible (e.g., a section of a display object at the edge of the display). In this example, the user interface elements in the second page can appear to be falling off of the edge of the display or can appear smaller, dimmer, less clear, or otherwise secondary to the user interface elements in the first page. In another example, a navigational guide 704 within the display can indicate to the user that there is additional information to be presented (e.g., second or additional pages of user interface elements). In some implementations, the navigational guide 704 can be shaped as a grid, a row, column, an arced or fan-out pattern, etc. For example, the navigational guide illustrated in FIG. 7A shows that there are three vertically scrollable pages of user interface elements. The second page of user interface elements, in some implementations, may include one or more of the elements included within the first page of user interface elements. For example, during user navigation of pages of user interface elements, one or more of the previously displayed elements may remain within the display when the user navigates to the second page of elements.

Any number of pages of user interface elements can be available for navigation. In some implementations, the user can be presented with a looping display of pages of user interface elements. For example, upon detection of a first horizontal left-to-right swipe, the first page of user interface elements is replaced with the second page of user interface elements within the touch-sensitive display. Upon detection of a second horizontal left-to-right swipe by the user, the first page of user interface elements can be displayed to the user again. In some other implementations, the user may be presented with no change in information upon the second left-to-right swipe, but a right-to-left swipe can return the user to the first page of user interface elements. In some implementations, once a gesture has been received by the touch-sensitive display, the pages of user interface elements continue to scroll until a stop indication has been received by the user or until reaching the end of the pages of user interface elements. For example, the user can touch the display using a stop gesture (e.g., tap or press), select a user interface element, press a button on the mobile device, etc. The scrolling can be animated and can be accelerated in response to quicker, repeated gestures or de-accelerated in response to slower, repeated gestures, to give a Rolodex effect.

FIG. 6 illustrates an example process 600 for indicating a restricted status of a user interface element on a mobile device. In some implementations, the process 600 can be used with the mobile device 100 or 101, as described in reference to FIG. 1A, 1B. Generally, the process 600 includes presenting information regarding the status of an application available on a mobile device.

The process 600 begins with presenting on the display of a mobile device a first user interface element corresponding to a first application in a manner indicating an unrestricted status of the first application (602). The user interface element, for example, can be one of the display objects 106 (as shown in FIG. 1A). In some implementations, denotation of an unrestricted status of an application can be performed by displaying the user interface element using a brightness level, contrast, highlight, or other visual indicator of an unrestricted status. For example, an unrestricted application can be represented by a bright user interface element (e.g., icon image) with high contrast against the background screen. The contrast can be accentuated, in some examples, by a highlighted outline or frame.

A second user interface element is presented corresponding to a second application, indicating a restricted status of the second application (604). The user interface element, for example, can be one of the display objects 106 (as shown in FIG. 1A). In some implementations, denotation of a restricted status can be performed by displaying the user interface element using a brightness level, contrast, highlight, or other visual indicator of a restricted status. For example, a restricted application can be represented by a dimmed, lower resolution, or partially transparent user interface element (e.g., icon image) with low contrast against the background screen. In some implementations, one or more user interface elements can be framed in a manner (e.g., a dark box, dashed outline, or separate tray area) indicative of the restricted status of the application(s). A symbol can overlay the user interface element, in some implementations, to denote the restricted status of the application. For example, a transparent word or image can be presented on top of the user interface element.

The status of the second application is changed from restricted to unrestricted (606). In some implementations, the user selects the interface element associated with the second application and is presented with the option of changing the status of the application. For example, the user can be prompted (e.g., within a new display or within a dialog box overlaying the present display) with the opportunity to purchase the second application. If the user chooses to purchase the application, the status of the application can change from restricted to unrestricted. In another example, the user can be prompted to supply a password or identification number to gain access to the application. In some other implementations, the restricted status can be changed from outside the mobile device. For example, a user can contact the service provider of the mobile device (e.g., call on the telephone, contact through a website on a computer, etc.) and place an order for the application. In this example, the mobile device can then receive a signal (e.g., via the communications devices 186 or 188, through a link from a computer using the port device 190, etc.) providing the mobile device with the new status of the application. In some implementations, changing the status of the application can include downloading additional software, files or other data to allow the application to run. In some other implementations, the application can require a key to unlock encrypted code within the mobile device.

Once the status of the second application has been changed from restricted to

unrestricted, the second user interface element is displayed without the indication of a restricted status (608). For example, the second user interface element can be displayed in the manner described above for indicating the unrestricted status of the application.

In some other implementations, the second application can be available on a trial basis. For example, the user can be presented with an option to access a trial version of the application, in some implementations containing a limited version of the capabilities of the application. A means of indicating a trial status of the second application, in some implementations, can be applied to the user interface element. For example, a dashed outline or transparent word or symbol overlay of the user interface element can indicate that the second application is unrestricted for a limited amount of time.

### Example Mobile Device with Vertically Scrolling Menu

FIGS. 7A-7C contains block diagrams of the example mobile device 101 with a vertically scrolling application menu. Referring to FIG. 7A, a second page of display objects 702 is partially covered by the menu bar 118 within the touch-sensitive display 102. In comparison to the first page of display objects 106, in some implementations, the second page of display objects 702 could be dimmer, transparent, or outlined in a manner indicating that the display objects in the second page are not yet active (e.g., not selectable within the touch-sensitive display 102).

As shown in FIG. 7B, the touch-sensitive display 102 contains a modified view of the display objects 106, 702. The mobile device 101 detects a gesture 710 in an upward (vertical) direction in relation to the display 102. In some implementations, the gesture 710 is detected within a navigational region 712 of the touch-sensitive display 102. For example, the navigational region 712 may be left clear of elements such as display objects 106, 702 to provide a section of the display in which a user can input navigational gestures. For example, navigational gestures can include swiping or dragging, with a finger or stylus, in the direction in which the user wishes the display to move. In some other implementations, navigational gestures can include tapping, pressing, swiping, or dragging within a navigational guide 704 presented in the navigational region 712.

In response to the gesture 710, the first page of display objects 106 shifts upwards and are partially obscured by an information panel 714 at the top of the display 102. The information panel can include the current time and a battery indicator icon. The display objects in the first page of display objects appear less vivid. In some implementations, the first page of display objects 106 are rendered in a different method to indicate that those user interface elements are no longer actively selectable within the touch-sensitive display 102. The second page of display objects 702 is now fully visible within the display 102, and the display objects 702 are rendered in a sharp, vivid presentation. In some implementations, the presentation of the second page of display objects 702 is indicative of the display objects being actively selectable within the touch-sensitive display 102.

As shown in FIG. 7C, the first page of display objects 106 is partially visible beneath the information panel 714. The visible portions of the clock object 148, the calculator object 138, and the settings object 152 appear dimmer, transparent, less vivid, or outlined to indicate that these objects are not active. The second page of display objects 702 are located directly beneath the first page of display objects 106. In some implementations, the second page of display objects 702 moves from below the navigational region 712 to above the navigational region 712. In some implementations, the additional movement of the display objects 106, 702 occurs due to an additional gesture 710 by the user. In some other implementations, the display 102 continues to scroll due to the initial gesture 710 until the user inputs a stop gesture (e.g., tap, etc.) or makes another input such as selecting one of the display objects 104, 106, 702, pressing the button 120, etc.

### Example Mobile Device with Horizontally Scrolling Menu

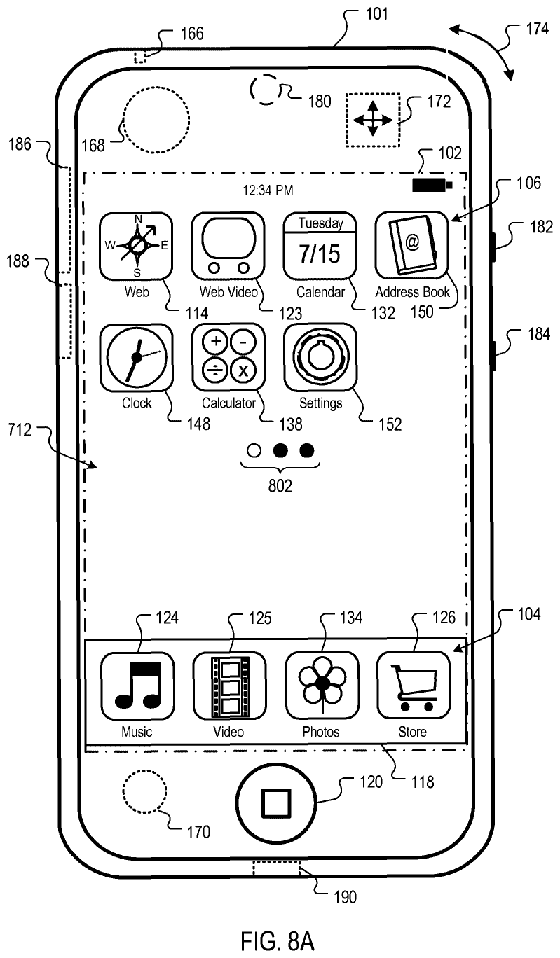

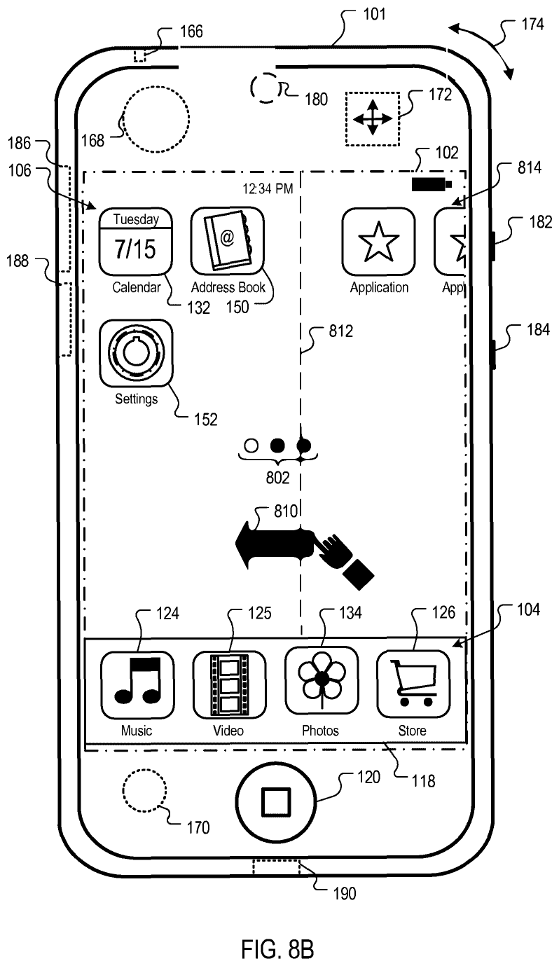

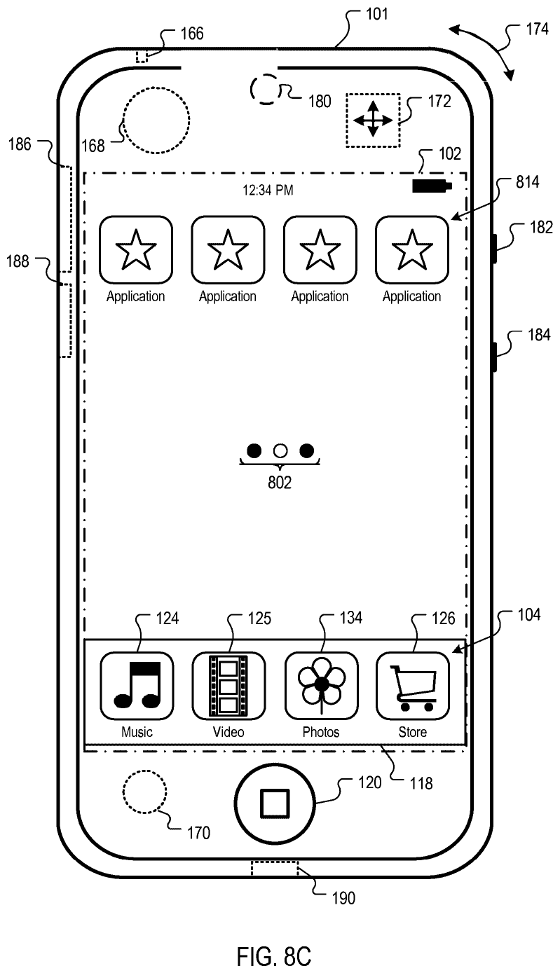

FIGS. 8A-8C contains block diagrams of the example mobile device 101 with a horizontally scrolling application menu. Referring to FIG. 8A, the touch-sensitive display 102 contains a set of three page indicator dots 802 within the navigational region 712. The leftmost dot is open or filled with a bright color (e.g., white), while the middle and rightmost dots are filled with a dark color (e.g., black). In some implementations, the leftmost open dot is indicative of a first page within the display 102. For example, the open dot can refer to the page in which the display objects 106 appear. In some implementations, dragging or swiping in a horizontal manner within the navigational region 712 causes the display to change to the second and/or third pages as indicated by the page indicator dots 802. There can be any number of page indicator dots 802 displayed within the navigational region 712. In some implementations, rather than page indicator dots 802, the navigational region can contain a navigational guide. The navigational guide, for example, can provide the opportunity for both horizontal and vertical navigation within the display 102.

As shown in FIG. 8B, upon detecting a gesture 810, the display 102 within the mobile device 101 is modified to reflect horizontal movement towards the second page of display objects as referenced by the indicator dots 802. FIG. 8B illustrates an instant in the horizontal movement from the first page to the second page, with reference line 812 marking the boundary between the first page and the second page. The visible portion of the first page includes a portion of the display objects 106 (e.g., the calendar object 132, the address book object 150, and the settings object 152), and the visible portion of the second page includes a portion of set of display objects 814. One of the display objects 814 is only partially visible within the display 102. In some implementations, partially displayed objects (e.g., display objects in which a percentage of the object is not contained within the region of the visible display) are rendered in a manner which reflects an inactive status. For example, a partially displayed object can be rendered in a transparent, dim, or low resolution image to indicate to the user that the object is not currently selectable.

The page indicator dots indicate that the first page (leftmost open dot) continues to be active. In some implementations, when the gesture 810 is detected, the display scrolls horizontally from one page to another. In some other implementations, the display continues to scroll until a stop indication is detected. For example, the display could continue to scroll until selection of a display object 104, 106, 814, selection of the button 120, or other user input is detected. In some implementations, the second page of display objects 814 replaces the first page of display objects 106 without displaying an intermediate position. In some implementations, no visible reference line 812 is displayed between pages. For example, the scrolling pages can be rendered in the manner of a seamless rolling display.

Referring to FIG. 8C, the second page of display objects 814 is visible within the touch-sensitive display 102 of the mobile device 101. The middle circle of the page indicator dots 802 is open, reflecting the active page. In some implementations, a swiping or dragging gesture towards the left of the display 102 returns the user to the display illustrated within FIG. 8A. Similarly, a swiping or dragging gesture towards the right of the display 102, in some implementations, provides the user with access to additional pages of display objects.

### Example Mobile Device with Ergonomic Display

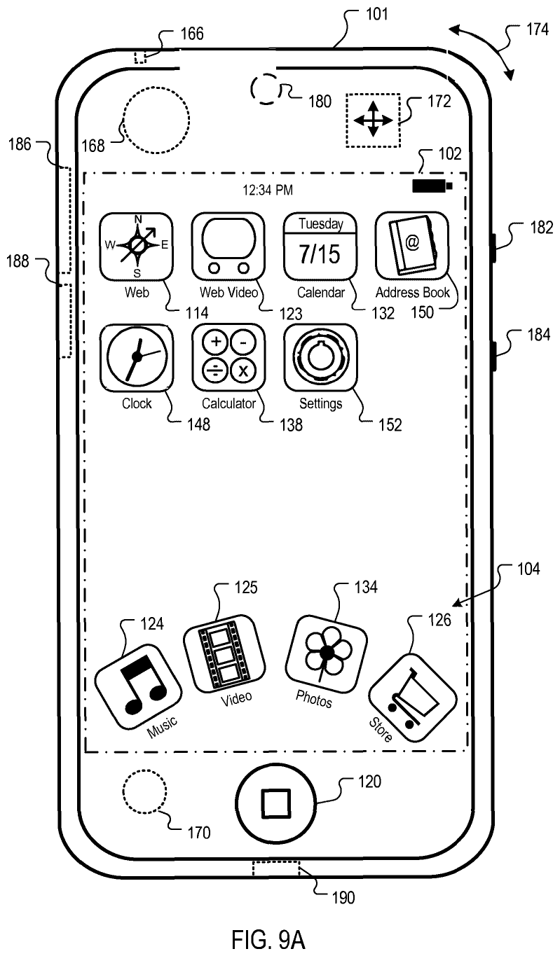

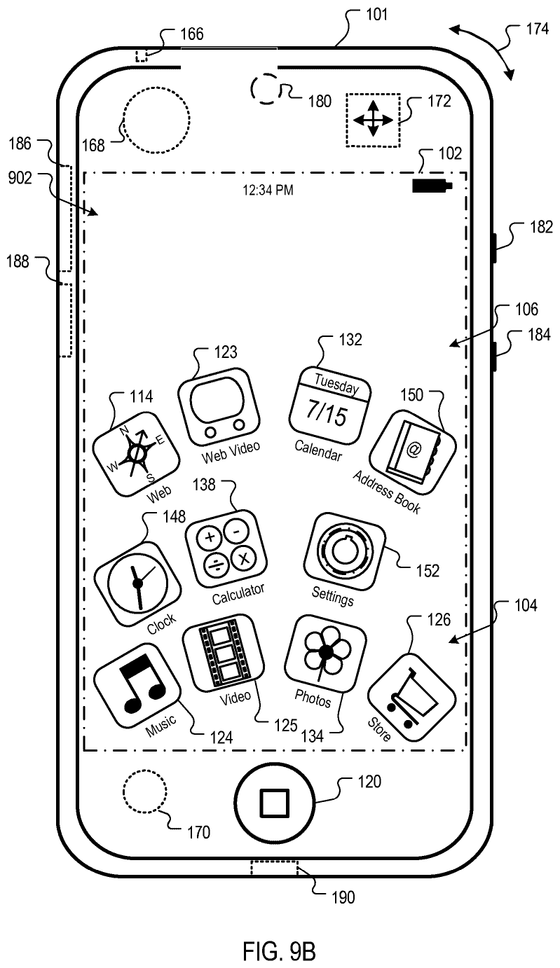

FIG. 9A is a block diagram of the example mobile device 101 with an ergonomic touch-sensitive menu bar layout. The display objects 104 are arranged in an arc. For example, the arrangement of the display objects 104 follows the sweep of the thumb of a user. In some implementations, the user initiates the positioning and radius of the arc through a touch range setup. For example, selecting the settings object 152 could present the user with the option of initializing the touch-sensitive display 102 in an ergonomic manner. In some other implementations, the ergonomic presentation of the display objects 104 can use a default arc arrangement. The arc presentation of the display objects 104 versus the menu bar presentation 118 (as shown in FIG. 1B), in some implementations, may be a choice available to the user within user-selectable settings (e.g., selecting the settings object 152).

FIG. 9B is a block diagram of the example mobile device 101 with an ergonomic touch-sensitive display object layout. The display objects 106 in addition to the display objects 104 are arranged in three stacked arcs. The music object 124, the video object 125, the photos object 134, and the store object 126 are arranged in the bottom-most arc. The clock object 148, the calculator object 138, and the settings object 152 are arranged in a middle arc, and the web object 114, the web video object 123, the calendar object 132, and the address book object 150 are arranged in a top-most arc. In some implementations, an upper region 902 is left blank as a navigational region (e.g., as described in FIG. 7B). In some other implementations, display objects can populate the entire display area 102. In some implementations, the user can set a maximum distance for the ergonomic display object layout. For example, within a setup option (e.g., through the settings object 152), the user could input a thumb sweep gesture, indicating the range of comfortable motion for an ergonomic display region. Displaying additional objects which may not fit within the range of comfortable motion, for example, can be accomplished by aligning the objects in straight rows from the top of the display 102 downwards, in a manner similar to the layout of the display objects 106 as illustrated within FIG. 9A.

### Example Mobile Device Displaying Elements Indicating a Restricted Status

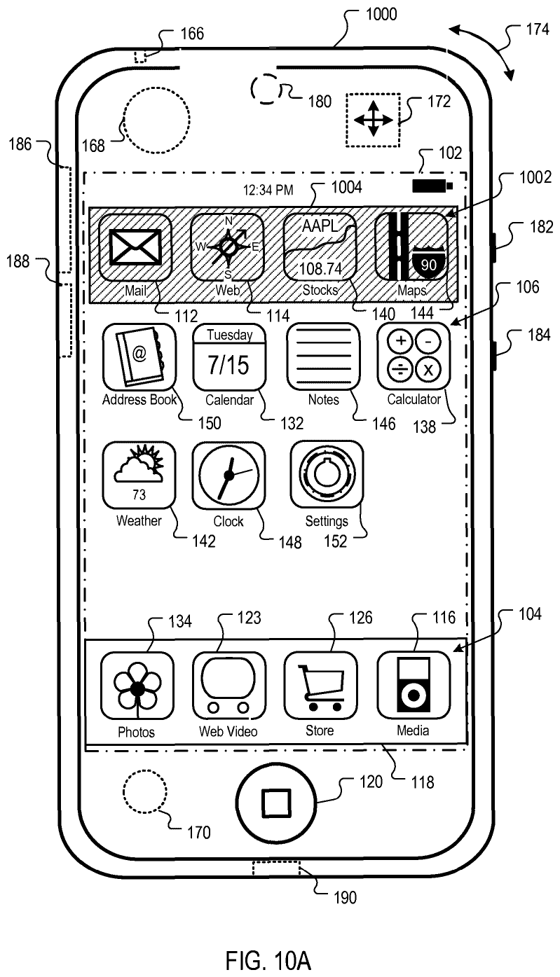

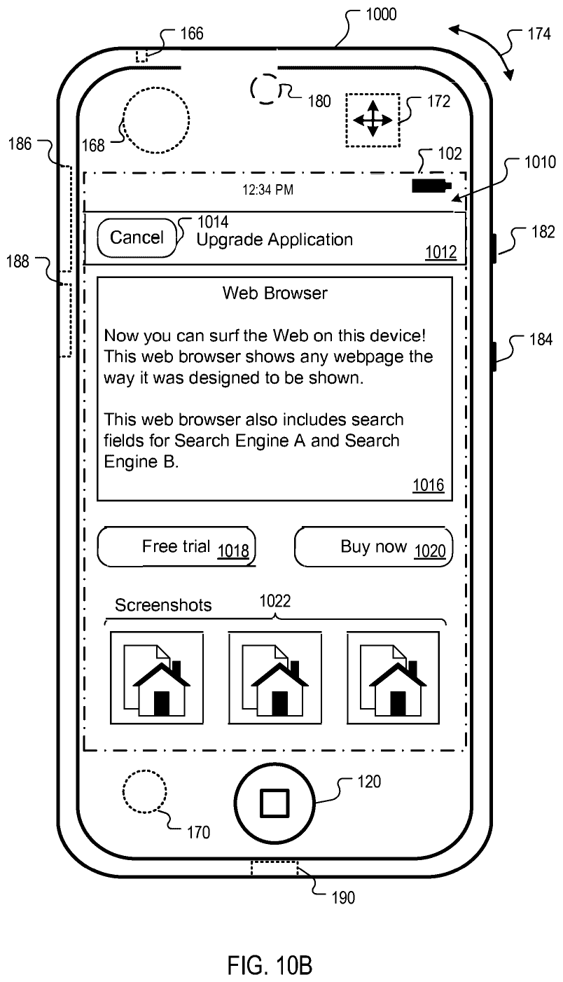

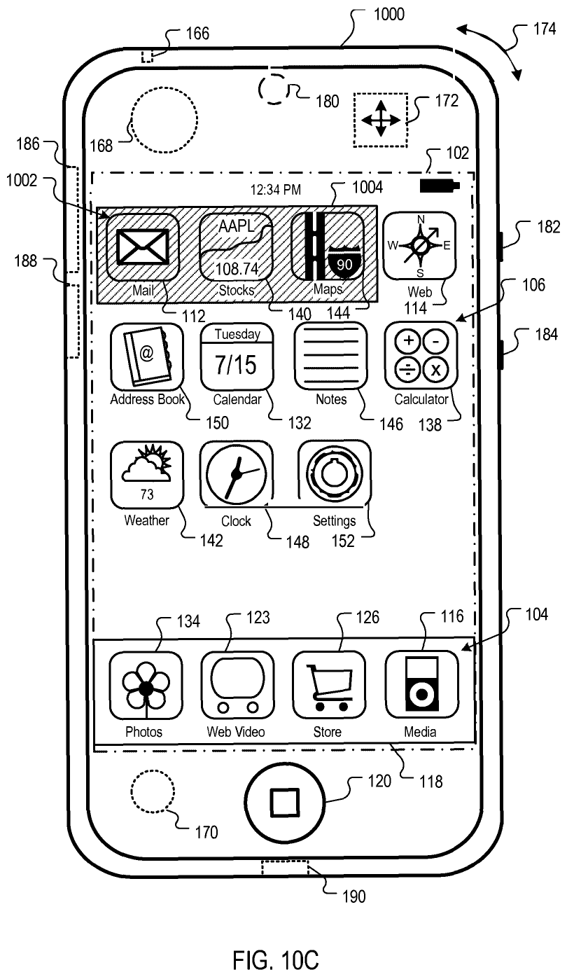

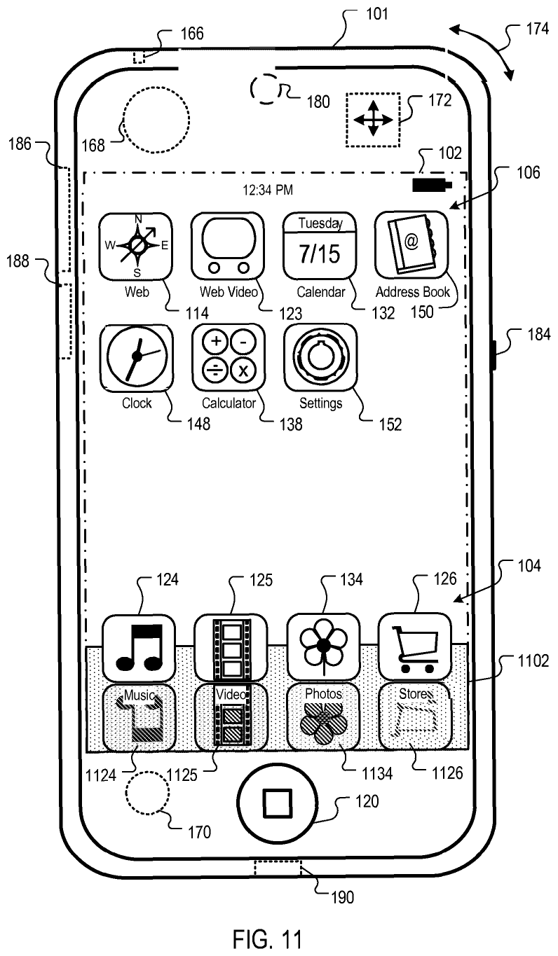

FIG. 10A is a block diagram of an example mobile device 1000 displaying user interface elements associated with applications which have a restricted status. A set of display objects 1002 are arranged within a restricted applications tray 1004. The display objects 1002 and the tray 1004 are cross-hatched to make them appear darker than the remaining display objects 106, 104 within the touch-sensitive display 102 of the mobile device 1000. The display objects 1002 include the e-mail object 112, the web object 114, the stocks object 140, and the maps object 144. Any number of restricted display objects 1002, in some implementations, can be arranged within the tray 1004. In some implementations, rather than being arranged within a restricted applications tray 1004, visual indications within the restricted display objects 1002 can be used to associate the display objects 1002 with restricted applications. In some examples, the restricted status display objects 1002 can be outlined with a dashed line, made transparent, overlaid with a transparent indicator of restricted status (e.g., text or image), etc.

In some implementations, the applications associated with the display objects 1002 are not presently available for use within the mobile device 1000. For example, to use the e-mail application associated with the e-mail object 112, the user can select the e-mail object 112 and purchase/activate the e-mail application. The applications associated with the restricted display objects 1002, in some implementations, are not fully installed within the mobile device 1000. For example, upon selecting the e-mail object 112 and purchasing the e-mail application, some portion of the e-mail application can be downloaded to the mobile device 1000 (e.g., via the communications devices 186 or 188, through a link from a computer using the port device 190, etc.).

FIG. 10B is a block diagram of the example mobile device 1000 displaying an information dialog 1010 regarding the restricted web object 114. The information dialog 1010, for example, can open upon selecting the web object 114 from within the restricted object tray 1004 (as shown in FIG. 10A). A title bar 1012 alerts the user to the opportunity to upgrade the application. A cancel button 1014 provides the user with the option to decline the offer. Selection of the cancel button 1014, for example, can return the user to the display 102 as shown within FIG. 10A. A message box 1016 contains information regarding the capabilities of the restricted application (e.g., a web browsing application associated with the web object 114). In some implementations, navigational means can exist within the message box 1016. For example, if the description of the application does not fit within the space provided by the message box 1016, a scroll bar or other navigational means can be provided to the user to view the remaining information regarding the application. A set of screenshots 1022 illustrate example display layouts using the application associated with the restricted web object 114. For example, the screenshots 1022 can illustrate the browsing, searching, and bookmarking capabilities of the web browser application.

A free trial button 1018 gives the user the opportunity to try the application for a limited time. In some implementations, a version of the application with limited functionality or other limitations is provided to the user during the free trial. For example, the free trial version of the web browsing application can have some features (e.g., bookmarking, history, customized settings, etc.) disabled. A buy now button 1020, in some implementations, can open a further dialog to provide the user with the opportunity to purchase the application. In some implementations, upon selection of the buy now button 1020 or the free trial button 1018, the mobile device 1000 downloads some or all of the application software. In some other implementations, the mobile device 1000 can download a security element (e.g., password, cryptographic key, authorization code, etc.) to unlock the application. For example, the mobile device 1000 can download an encryption key to decrypt the application.

FIG. 10C is a block diagram of the example mobile device 1000 displaying the web object 114 with an unrestricted status. The web object 114 is no longer located within the restricted tray 1004, and the tray 1004 has been resized accordingly. The web object 114 is free of the hatch-marking associated with the restricted status display objects 1002. In some implementations, the web object 114 is displayed with unrestricted status because the user selected the buy now button 1020 or the free trial button 1018 within the information dialog 1010 (as shown in FIG. 10B). In some other implementations, the user can modify the status of the web application associated with the web object 114 outside of the device 1000. For example, the user could call the service provider of the mobile device 1000 or access the web site of the service provider 1000 to purchase the web application associated with the web display object 114. Upon request by the user, the service provider could then upload to the mobile device 1000 application content and/or a decryption means for making the application available to the user on the mobile device 1000.

In some implementations, upon selecting the free trial button 1018, the web display object 114 could be rendered in a method indicating the temporary availability of the web application. For example, the web display object 114 could be displayed surrounded by a dashed line, overlaid with a transparent symbol, or embellished with another indication representing the temporary status of the availability of the application for use within the device 1000.

### Example Mobile Device with Alternative Display

FIG. 11 is a block diagram of the example mobile device 101 with interface elements docked to a menu tray floor. A docking tray 1102 contains the display objects 104. The music object 124 stands above the docking tray 1102 with a reflection object 1124 beneath it. Similarly, the video object 125, the photo object 134, and the store object 126 are mirrored by the reflection objects 1125, 1134, and 1126. In some implementations, selection of one of the display objects 104 launches the application associated with the display object 104, while selection of the reflection object 1124, 1125, 1134, or 1126 launches an information dialog regarding the associated display object 104. For example, selection of the reflection object 1134 can open a settings dialog associated with the photos application. In some implementations, the reflection objects 1124, 1125, 1134, 1126 are not user-selectable. A display object 104, 106, in some implementations, can be dragged and dropped between the docking tray 1102 and the region of the display 102 which contains the display objects 106. For example, the user can choose to populate the docking tray 1102 with any set (e.g., set of four) of display objects 104, 106 for quick access (e.g., favorites).

In some implementations, the display objects 104, 106 can be repositioned by a user. For example, a user can initiate an interface reconfiguration mode on the device 100 or 101. While in the interface reconfiguration mode, the display objects 104, 106 are movable by the user. The user can touch one of the display objects and drag it to the desired position. The user can drag the display object to an empty position in the display 102, menu bar 118, or docking tray 1102 to drop the display object into that position, to drag the display object to a position between two other display objects to insert the dragged display object into that position, or to drag the display object over another display object in the display 102, menu bar 118, or docking tray 1102 to have the two display objects exchange positions, for example. The repositioning of display objects on a touch-sensitive display is described in further detail in U.S. patent application Ser. No. 11/459,602, titled “Portable Electronic Device with Interface Reconfiguration Mode,” filed Jul. 24, 2006, the disclosure of which is incorporated by reference in its entirety.

In implementations where user interface elements (e.g., display objects 106) can be displayed in multiple pages and the user can navigate between the pages (e.g., as described above in reference to FIGS. 7A-7C and 8A-8C), the user can drag a display object from one page to another. For example, a user can drag a display object within a first page toward the edge of the display 102. When the display object is dragged to within a predetermined distance from the edge of the display (e.g., 5 pixels), a second page is displayed. The user can then position the dragged display object within the second page.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

1. (canceled)

2. An electronic device, comprising:
a display;
one or more processors;
memory; and
one or more programs, wherein the one or more programs are stored in the memory and configured to be executed by the one or more processors, the one or more programs including instructions for:
displaying, via the display:
a first page user interface of a multi-page user interface, wherein the first page user interface includes a first set of application icons; and
a set of page indicators;
while displaying the first page user interface of the multi-page user interface that includes the first set of applications icons, detecting an input; and
in response to detecting the input:
replacing the first page user interface of the multi-page user interface with a second page user interface of the multi-page user interface, wherein the second page user interface includes a second set of application icons; and
updating an appearance of the set of page indicators to reflect the replacement of the first page user interface of the multi-page user interface with the second page user interface of the multi-page user interface.

3. The electronic device of claim 2, wherein the set of page indicators are a set of graphical objects.

4. The electronic device of claim 2, wherein the set of page indicators includes a first graphical object corresponding to the first page user interface of the multi-page user interface and a second graphical object corresponding to the second page user interface of the multi-page user interface, wherein the first page user interface is different from the second page user interface.

5. The electronic device of claim 4, wherein:
in accordance with a determination that the first page user interface of the multi-page user interface is a currently displayed page user interface, displaying the first graphical object with a first visual characteristic and the second graphical object with a second visual characteristic different from the first visual characteristic; and
in accordance with a determination that the second page user interface of the multi-page user interface is a currently displayed page user interface, displaying the second graphical object with the first visual characteristic and the first graphical object with the second visual characteristic different from the first visual characteristic.

6. The electronic device of claim 5, wherein the first visual characteristic corresponds to a first highlighting and the second visual characteristic corresponds to a second highlighting different from the first highlighting.

7. The electronic device of claim 5, wherein the first visual characteristic corresponds to a first color and the second visual characteristic corresponds to a second color different from the first color.

8. The electronic device of claim 2, wherein an amount of page indicators in the set of page indicators corresponds to an amount of page user interfaces in the multi-page user interface.

9. The electronic device of claim 2, wherein the page indicators in the set of page indicators provide information about a position of a currently displayed page user interface in a sequence of the multi-page user interface.

10. The electronic device of claim 2, wherein the input corresponds to a horizontal movement gesture.

11. The electronic device of claim 2, the one or more programs further including instructions for:
while displaying the first set of application icons, detecting an input directed to an application icon from the set of application icons; and
in response to detecting the input directed to the application icon, launching an application corresponding to the application icon.

12. A non-transitory computer readable storage medium storing one or more programs configured to be executed by one or more processors of an electronic device with a display, the one or more programs including instructions for:
displaying, via the display:
a first page user interface of a multi-page user interface, wherein the first page user interface includes a first set of application icons; and
a set of page indicators;
while displaying the first page user interface of the multi-page user interface that includes the first set of applications icons, detecting an input; and
in response to detecting the input:
replacing the first page user interface of the multi-page user interface with a second page user interface of the multi-page user interface, wherein the second page user interface includes a second set of application icons; and
updating an appearance of the set of page indicators to reflect the replacement of the first page user interface of the multi-page user interface with the second page user interface of the multi-page user interface.

13. The non-transitory computer readable storage medium of claim 12, wherein the set of page indicators are a set of graphical objects.

14. The non-transitory computer readable storage medium of claim 12, wherein the set of page indicators includes a first graphical object corresponding to the first page user interface of the multi-page user interface and a second graphical object corresponding to the second page user interface of the multi-page user interface, wherein the first page user interface is different from the second page user interface.

15. The non-transitory computer readable storage medium of claim 14, wherein:
in accordance with a determination that the first page user interface of the multi-page user interface is a currently displayed page user interface, displaying the first graphical object with a first visual characteristic and the second graphical object with a second visual characteristic different from the first visual characteristic; and
in accordance with a determination that the second page user interface of the multi-page user interface is a currently displayed page user interface, displaying the second graphical object with the first visual characteristic and the first graphical object with the second visual characteristic different from the first visual characteristic.

16. The non-transitory computer readable storage medium of claim 15, wherein the first visual characteristic corresponds to a first highlighting and the second visual characteristic corresponds to a second highlighting different from the first highlighting.

17. The non-transitory computer readable storage medium of claim 15, wherein the first visual characteristic corresponds to a first color and the second visual characteristic corresponds to a second color different from the first color.

18. The non-transitory computer readable storage medium of claim 12, wherein an amount of page indicators in the set of page indicators corresponds to an amount of page user interfaces in the multi-page user interface.

19. The non-transitory computer readable storage medium of claim 12, wherein the page indicators in the set of page indicators provide information about a position of a currently displayed page user interface in a sequence of the multi-page user interface.

20. The non-transitory computer readable storage medium of claim 12, wherein the input corresponds to a horizontal movement gesture.

21. The non-transitory computer readable storage medium of claim 12, the one or more programs further including instructions for:
while displaying the first set of application icons, detecting an input directed to an application icon from the set of application icons; and
in response to detecting the input directed to the application icon, launching an application corresponding to the application icon.

22. A method, comprising:
at an electronic device with a display:
displaying, via the display:
a first page user interface of a multi-page user interface, wherein the first page user interface includes a first set of application icons; and
a set of page indicators;
while displaying the first page user interface of the multi-page user interface that includes the first set of applications icons, detecting an input; and
in response to detecting the input:
replacing the first page user interface of the multi-page user interface with a second page user interface of the multi-page user interface, wherein the second page user interface includes a second set of application icons; and
updating an appearance of the set of page indicators to reflect the replacement of the first page user interface of the multi-page user interface with the second page user interface of the multi-page user interface.

23. The method of claim 22, wherein the set of page indicators are a set of graphical objects.

24. The method of claim 22, wherein the set of page indicators includes a first graphical object corresponding to the first page user interface of the multi-page user interface and a second graphical object corresponding to the second page user interface of the multi-page user interface, wherein the first page user interface is different from the second page user interface.

25. The method of claim 24, wherein:
in accordance with a determination that the first page user interface of the multi-page user interface is a currently displayed page user interface, displaying the first graphical object with a first visual characteristic and the second graphical object with a second visual characteristic different from the first visual characteristic; and
in accordance with a determination that the second page user interface of the multi-page user interface is a currently displayed page user interface, displaying the second graphical object with the first visual characteristic and the first graphical object with the second visual characteristic different from the first visual characteristic.

26. The method of claim 25, wherein the first visual characteristic corresponds to a first highlighting and the second visual characteristic corresponds to a second highlighting different from the first highlighting.

27. The method of claim 25, wherein the first visual characteristic corresponds to a first color and the second visual characteristic corresponds to a second color different from the first color.

28. The method of claim 22, wherein an amount of page indicators in the set of page indicators corresponds to an amount of page user interfaces in the multi-page user interface.

29. The method of claim 22, wherein the page indicators in the set of page indicators provide information about a position of a currently displayed page user interface in a sequence of the multi-page user interface.

30. The method of claim 22, wherein the input corresponds to a horizontal movement gesture.

31. The method of claim 22, the method further comprising:
while displaying the first set of application icons, detecting an input directed to an application icon from the set of application icons; and
in response to detecting the input directed to the application icon, launching an application corresponding to the application icon.
